(19) United States
(12) Patent Application Publication
(10) Pub. No.: US 2002/0124694 A1
(43) Pub. Date: Sep. 12, 2002

(54) Splatter guard

(76) Inventor: Timothy J. Vandiver, Apple Valley, CA (US)

Correspondence Address: Richard C. Litman, LITMAN LAW OFFICES, LTD., P. O. Box 15035, Arlington, VA, 22215, US

(21) Appl. No.: 09/799,083

(22) Filed: Mar. 6, 2001

(51) Int. Cl. B23B 25/00; B23B 3/00

(52) U.S. Cl. 82/52; 82/152

(57) ABSTRACT

The splatter guard is an attachment for a portable pipe machine tool which catches the chips and lubricating oil thrown off by the machine during pipe cutting and threading operations to prevent splattering of the jobsite or workplace. The splatter guard is generally funnel shaped, having a rectangular or square upper portion with an open mouth, and a pyramidal lower portion tapering to a spout. A backdrop extends upwardly from the back side of the open mouth for catching back splatter. A channel arm extends from the machine attachment side of the splatter guard for sliding engagement with a sleeve mounted on the machine's tripod. The machine attachment side of the upper portion has a semicircular cutout so that the mouth of the splatter guard may be aligned flush under the carriage from the chuck to carriage end.

### BACKGROUND OF THE INVENTION

1. Field of the Invention

The present invention relates generally to splatter guards and more particularly, to a splatter guard for a pipe machine tool. The splatter guard is designed to catch 95-100% of the debris that results from cutting, reaming, and threading a pipe.

2. Description of the Related Art

The process of cutting, reaming, and threading a pipe produces an incredible mess that must be repeatedly cleaned up to maintain a clean and safe work area. People in the various trades that use pipe threading machines are confronted with this situation on a daily basis. To minimize or even eliminate this mess, the tradesman usually has to lay down some material such as cardboard, plywood, drywall, plastic tarping or a combination of the various materials to collect the accumulating waste and debris. Avoiding this messy cleanup is extremely important because the cutting oil has a nasty habit of staining everything with which it comes in a contact, such as clothes, floors, concrete, asphalt, walls, and anything else it might touch. The only thing that can be done is to remove whatever has been stained especially concrete and asphalt.

Therefore, additional costs are incurred because someone must be paid to clean up the area where the work was done and the permanently stained items must be replaced. Conventional solutions used to minimize the mess generated during the pipe preparation process have proven be woefully inadequate.

The prior art describes a variety of guard shields used to minimize or eliminate the scattering of debris during a machining process, for example, a guard casing for grinding machines is described in U.S. Pat. No. 1,689,719, issued on Oct. 30, 1928 to A. M. Drake. The guard casing, which is semicircular with a flattened upper portion and which is placed over the grinding wheel, is designed to protect the machine operator from flying abrasive or metal grindings. U.S. Pat. No. 2,203,979, issued on Jun. 11, 1940 to H. L. Blood, describes a guard arrangement for an internal grinding machine. The guard is used to safeguard the machine operator at all times from the dangers of grinding wheel breakage, accidental contact with either the rotating grinding wheel or the rotating work holder, and to effectively intercept and confine the splash of coolant fluid which is laden with abrasive particles that is thrown off at high velocity by the rapidly rotating wheel or workpiece. The guard encircles the grinding wheel and fits inside a second guard encircling the chuck.

A splash guard is described in U.S. Pat. No. 4,388,028, issued on Jun. 14, 1983 to M. L. Bodin. The splash guard is used in combination with a rotary oil hole type of cutting tool. The guard consists of an inducer ring rotatably mounted upon the rotary tool or the tool spindle and having a shielding sleeve axially slidable over the inducer. Liquid coolant is flowed through the inducer to the tool spindle and subsequently to the cutting tool edge where it is ejected at relatively high pressures. The presence of the shielding sleeve surrounding the tool prevents the coolant from splashing the operator and the operator work station.

U.S. Pat. No. 5,741,175, issued on Apr. 21, 1998 to R. E. Voegea, describes a flexible shield for a tile saw. The shield includes a plurality of panels that are preferably transparent which are assembled to fit over the tile saw and water tray. The four panels of the tile saw shield are easily erected and quickly dismantled. The erected shield effectively prevents water from spraying out of the tray.

A splash guard device for use in a machine tool is described in U.S. Pat. No. 5,971,679, issued on Oct. 26, 1999 to J. I. Kim. The splash guard is utilized in a machine tool to prevent chips and coolant from flying to the outside of a cutting compartment while permitting a smooth pallet changing operation. The splash guard includes a splash guard door capable of up/down movement and that swivels about a vertical axis in the course of a pallet changing operation. The splash guard prevents metal chips and coolant from flying over the upper and opposite side edges of the door during the course of the workpiece cutting operation.

None of the above inventions and patents, taken either singularly or in combination, is seen to describe the instant invention as claimed. Thus a splatter guard solving the aforementioned problems is desired.

### SUMMARY OF THE INVENTION

The splatter guard is an attachment for a portable pipe machine tool which catches the chips and lubricating oil thrown off by the machine during pipe cutting and threading operations to prevent splattering of the jobsite or workplace. The splatter guard is generally funnel shaped, having a rectangular or square upper portion with an open mouth, and a pyramidal lower portion tapering to a spout. A backdrop extends upwardly from the back side of the open mouth for catching back splatter. A channel arm extends from the machine attachment side of the splatter guard for sliding engagement with a sleeve mounted on the machine's tripod. The machine attachment side of the upper portion has a semicircular cutout so that the mouth of the splatter guard may be aligned flush under the carriage from the chuck to carriage end.

Accordingly, it is a principal object of the invention to provide a splatter guard that eliminates the messy cleanup required after cutting and threading a pipe.

It is another object of the invention to provide a splatter guard that catches 95-100% of the metal shavings and oil generated during a pipe cutting and threading process.

It is a further object of the invention to provide a splatter guard that is lightweight and easy to install.

Still another object of the invention is to provide a splatter guard that is attachable to a portable pipe cutting and threading machine for preventing splatter of cooling oil at the job site.

It is an object of the invention to provide improved elements; and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a splatter guard mounted on a pipe threading machine according to the present invention.

FIG. 2 is a front view of a splatter guard according to the present invention.

FIG. 3 is a side view of a splatter guard according to the present invention.

FIG. 4 is a section view along the lines 4-4 of FIG. 2.

FIG. 5 is a section view along the lines 5-5 of FIG. 2.

FIG. 6 is a bottom perspective view of a mounting tube attached to the tripod of a pipe threading machine for mounting the splatter guard according to the present invention.

Similar reference characters denote corresponding features consistently throughout the attached drawings.

### DETAILED DESCRIPTION OF THE PREFERRED EMBODIMENTS

The splatter guard of the present invention, designated generally as 10 in the drawings, is an attachment for a pipe threading and cutting machine which is designed to collect excess lubricant and cuttings thrown off by the machine while cutting or threading pipes. The splatter guard is particularly designed to work with a RIDGID® (RIDGID is a trademark of the Emerson Electric Co. of St. Louis, Mo. Model 300 power threading machine, which is a portable pipe threading machine commonly used by contractors. Although particularly well suited for use with the RIDGID® machine, the principles of the present invention are applicable to other machining tools which through off excess lubricant and cuttings during operation.

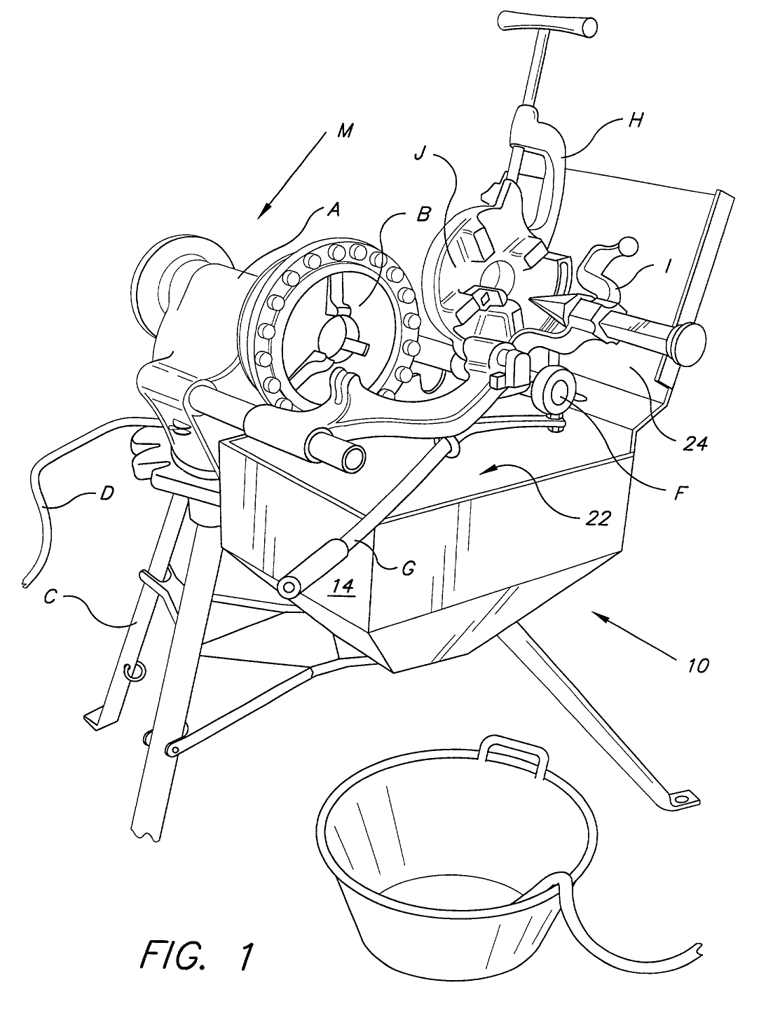

As shown in FIG. 1, the power threading machine M has a head A including a motor and chuck B for clamping and rotating a pipe, the head A being mounted on a tripod C. An electric cord D extends from the head A for connection to an electrical outlet. The machine M may have a foot pedal switch (not shown) for operating the motor. The machine M has a slidable carriage F or torsion arm operated by a lever G. Varios tools are rotatably mounted on the L carriage F, including a pipe cuter H, a reamer I, and a die head J in which various thread cutting dies may be mounted. The pipe threading machine is usually furnished with a bucket, or oiler pan, and an oiler gun (not shown) which are placed on the floor beneath the carriage F to collect and reuse and lubricant or cutting oil used to lubricate the cutter wheels, dies, or pipes during machining of the pipe. The tripod mounting and small profile of the machine M render it portable, so that the machine is easily transported and set up a job sites.

The problem which is frequently encountered in using the power threading machine is that the bucket is positioned so far beneath the carriage F that lubricating oil and metal cuttings splash and are thrown off the machine in such a pattern that much of the oil and cuttings are not collected in the bucket, but splash on the areas surrounding the bucket, and also rearward away from the operator of the machine. Consequently the floor and walls of the job site can become stained or marred by the oil and cuttings, and are difficult to clean due to the composition of the oil and the sometimes minute size of the cuttings.

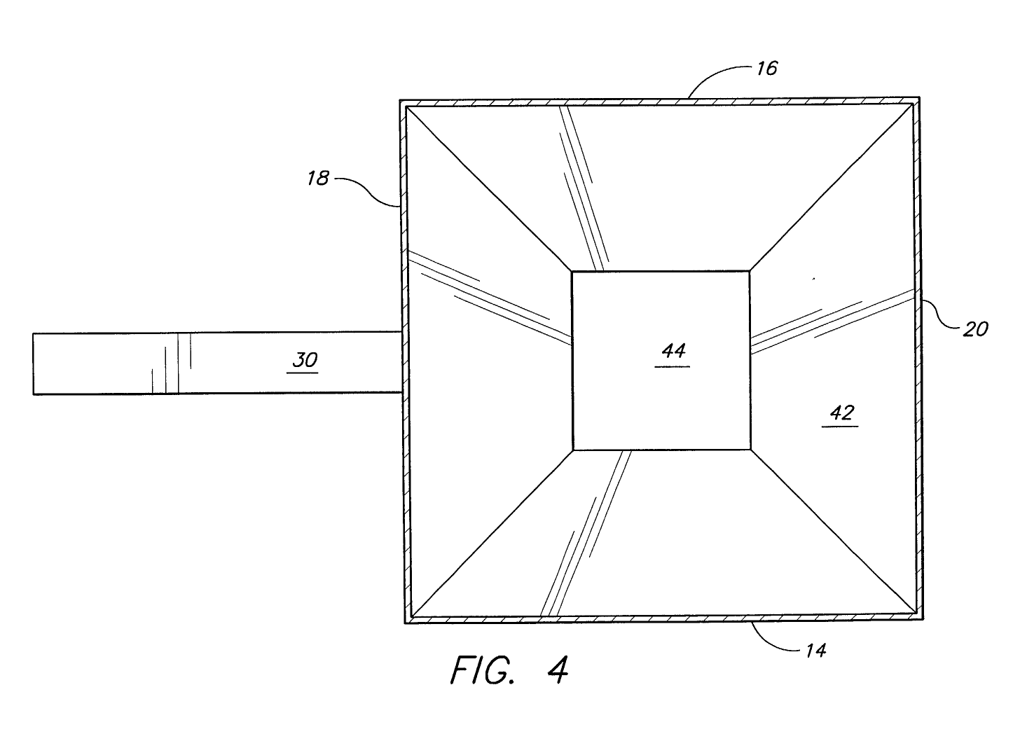

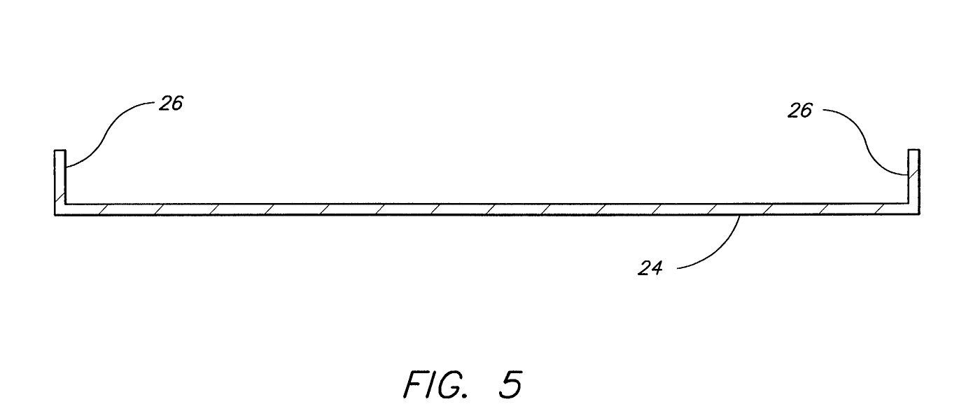

A shown in FIGS. 1-4, the splatter guard 10 is generally funnel shaped, having a rectangular upper portion 12 and a pyramidal lower portion 40. The rectangular upper portion 12 includes a front wall 14 which faces the machine's operator in use, a back wall 16, a proximal side wall 18 which is proximal to the machine M, and a distal side wall 20 which is distal to the machine M when the splatter guard is installed. The four walls of the upper portion 12 define an open mouth 22 which receives lubricant and cuttings thrown off by the machine M during operation. A backdrop 24 is attached to the back wall 16 and extends upward and rearward from the back wall 16 at a slight angle. The backdrop 24 catches any lubricant and cuttings thrown rearward due to the direction of rotation of the pipe, and the slope of the backdrop 24 directs the lubricant towards the open mouth 22. As shown in FIGS. 1 and 5, the backdrop 24 may have short upright flanges 26, about ½″ to inch high, extending along each side of the backdrop 24 which prevent oil from dripping over the sides of the backdrop 24 and channel the oil into the open mouth 22.

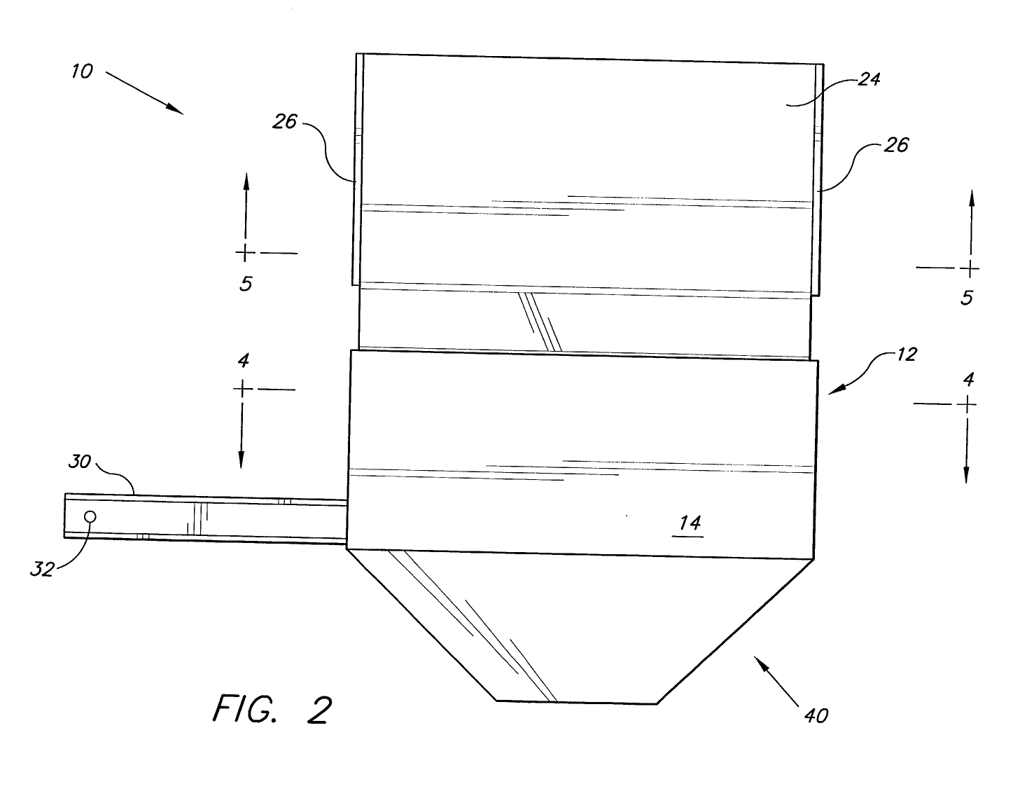

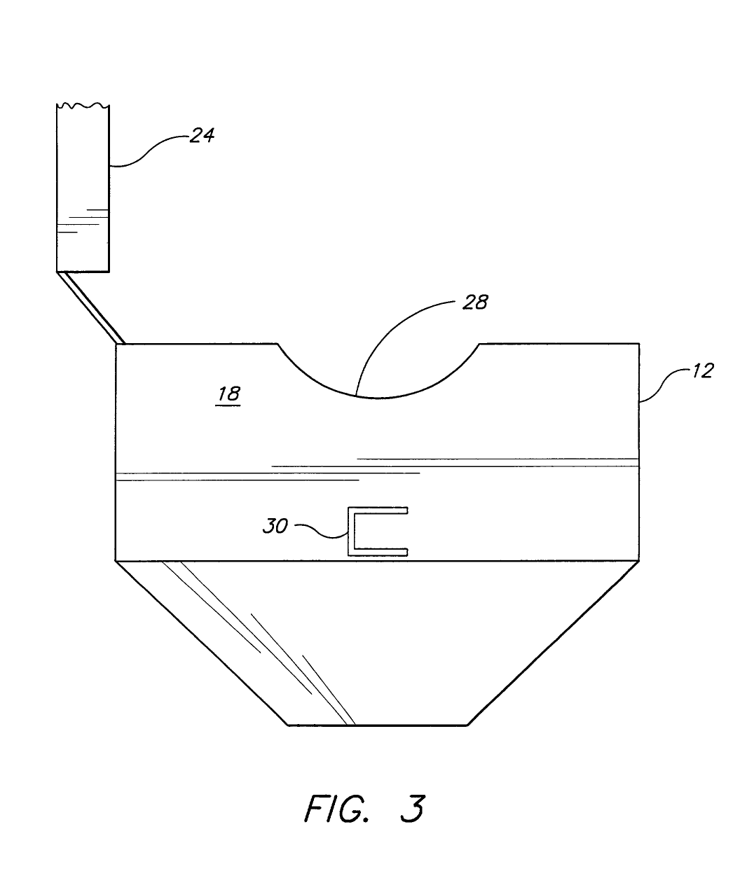

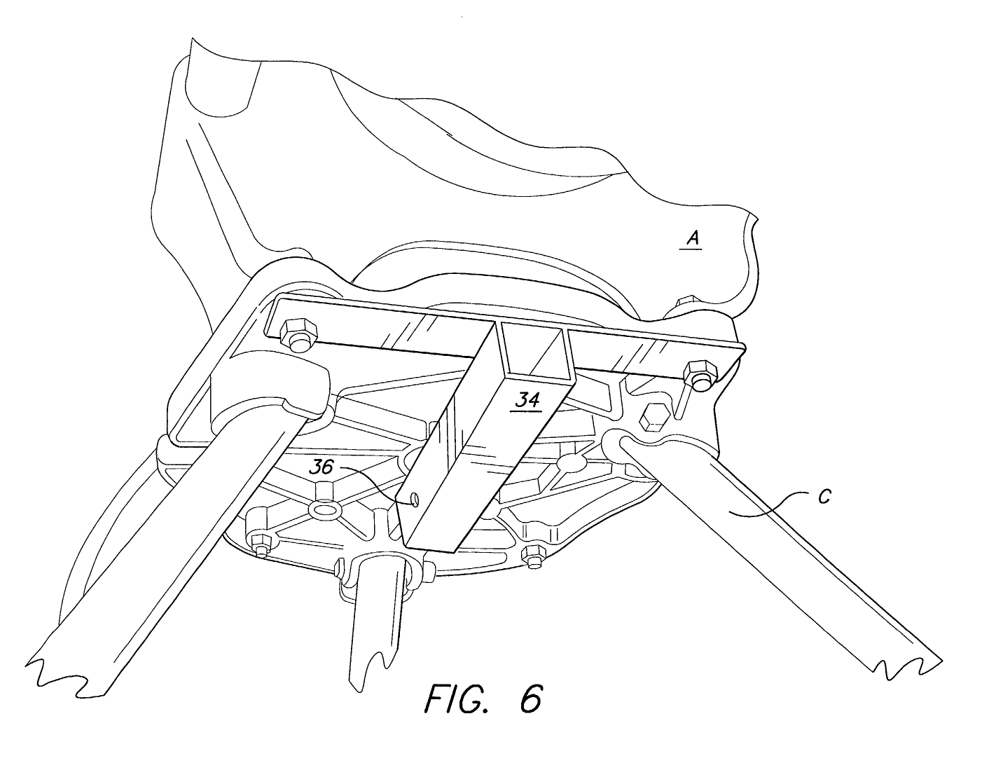

As shown in FIGS. 2-4, the splatter guard 10 has at least ones mounting arm 30 attached to the proximal wall 18 and extending from the proximal wall 18 after the fashion of a cantilever beam. The mounting arm 30 may be a U-shaped or C-shaped channel, and angle iron, or a square tube. The mounting arm 30 is slidable in a sleeve 34 made from elongated square tubing which is attached to the bottom of the tripod C plate, as shown in FIG. 6. The mounting arm 30 and the sleeve 34 may each have a hole 32 and 36, respectively, defined therein so that a bolt (not shown) can be passed through the aligned holes 32 and 36 and secured with a nut so the mounting arm does not slide out of the sleeve 34 due to machine vibration. Although only one mounting arm 30 is shown in the drawings, it will be understood that the splatter guard may have more than one mounting arm 30. As shown in FIG. 3, the proximal wall 18 may have a semicircular recess 28 defined along its top edge so that the proximal wall may be positioned directly under the chuck B, which locates the open mouth 22 as close to the pipe as possible. The size of the open mouth is dimensioned so that the mouth 22 extends from under the chuck to the ends of the carriage arms F, and from arm F to arm F.

The lower portion 40 of the splatter guard is pyramidal, or frustro-pyramidal shaped, with four side walls 42 which taper to a spout 44 or opening defined in the splatter guard 10. Lubricating oil and cuttings entering the open mouth 22 of the splatter guard 10 are funneled through the spout 44 and drain into the oil pan or bucket.

The splatter guard 10 may be made from thin sheet metal, from aluminum, or from molded plastic material.

It will be seen that the splatter guard 10 of the present invention offers an economical, convenient, and easy to use solution to the problem of splatter generated by machining tools, and particularly to power threading machines.

It is to be understood that the present invention is not limited to the embodiments described above, but encompasses any and all embodiments within the scope of the following claims.

I claim:

1. A splatter guard for a pipe threading machine having a head with a carriage arm extending from the head and a plurality of threading and cutting tools mounted on the carriage arms, the head being mounted on a tripod, the splatter guard comprising:
(a) a rectangular upper portion having an open mouth;
(b) a pyramidal lower portion extending from said upper portion and tapering to define a spout; and
(c) a planar backdrop extending upward and rearward from the open mouth of the upper portion, the backdrop having opposing sides;
wherein the splatter guard is attachable to the pipe threading machine with the open mouth of the upper portion disposed immediately below the carriage arms, the splatter guard defining a funnel for catching and channeling lubricating oil and cuttings into an oil pan, said backdrop preventing splatter rearward from the machine.

2. The splatter guard according to claim 1, wherein said upper portion has a front wall, a back wall, a proximal wall, and a distal wall.

3. The splatter guard according to claim 2, wherein the proximal wall has a top portion with a semicircular recess defined therein, the recess being sized and dimensioned to fit under the head of the machine so that the open mouth of said upper portion of the splatter guard extends from the head of the machine with the open mouth disposed under the carriage arms.

4. The splatter guard according to claim 1, wherein said backdrop has a pair of annular flanges extending from the opposing sides of the backdrop for channeling oil into the open mouth of said upper portion of the splatter guard.

5. The splatter guard according to claim 1, further comprising mounting means for mounting the splatter guard to the pipe threading machine.

6. The splatter guard according to claim 1, further comprising at least one cantilever mounting arm extending from said upper portion of the splatter guard, said mounting arm being slidable in a sleeve attached to the tripod of the pipe threading machine.

7. A splatter guard for a pipe threading machine having a head with a carriage arm extending from the head and a plurality of threading and cutting tools mounted on the carriage arms, the head being mounted on a tripod, the splatter guard comprising:
(a) a rectangular upper portion having a front wall, a back wall, a proximal wall, and a distal wall defining an open mouth, the proximal wall having a semicircular recess defined therein so that the proximal wall may be placed under the head of the machine; and
(b) a pyramidal lower portion extending from said upper portion and tapering to define a spout;
wherein the splatter guard is attachable to the pipe threading machine with the open mouth of the upper portion disposed immediately below the carriage arms, the splatter guard defining a funnel for catching and channeling lubricating oil and cuttings into an oil pan.

8. The splatter guard according to claim 7, further comprising a planar backdrop extending upward and rearward from the back wall of said upper portion, the backdrop having opposing sides, said backdrop preventing splatter rearward from the machine.

9. The splatter guard according to claim 8, wherein said backdrop has a pair of annular flanges extending from the opposing sides of the backdrop for channeling oil into the open mouth of said upper portion of the splatter guard.

10. The splatter guard according to claim 7, further comprising mounting means for mounting the splatter guard to the pipe threading machine.

11. The splatter guard according to claim 7, further comprising at least one cantilever mounting arm extending from the proximal wall of said upper portion of the splatter guard, said mounting arm being slidable in a sleeve attached to the tripod oft the pipe threading machine.

12. A splatter guard for a pipe threading machine having a head with a carriage arm extending from the head and a plurality of threading and cutting tools mounted on the carriage arms, the head being mounted on a tripod, the splatter guard comprising:
(a) a rectangular upper portion having an open mouth;
(b) a pyramidal lower portion extending from said upper portion and tapering to define a spout; and
(c) at least one cantilever mounting arm extending from said upper portion of the splatter guard, said mounting arm being slidable in a sleeve attached to the tripod of the pipe threading machine;
wherein the splatter guard is attachable to the pipe threading machine with the open mouth of the upper portion disposed immediately below the carriage arms, the splatter guard defining a funnel for catching and channeling lubricating oil and cuttings into an oil pan.

13. The splatter guard according to claim 12, wherein said upper portion has a front wall, a back wall, a proximal wall, and a distal wall.

14. The splatter guard according to claim 13, wherein the proximal wall has a top portion with a semicircular recess defined therein, the recess being sized and dimensioned to fit under the head of the machine so that the open mouth of said upper portion of the splatter guard extends from the head of the machine with the open mouth disposed under the carriage arms.

15. The splatter guard according to claim 12, further comprising a planar backdrop extending upward and rearward from the back wall of said upper portion, the backdrop having opposing sides, said backdrop preventing splatter rearward from the machine.

16. The splatter guard according to claim 15, wherein said backdrop has a pair of annular flanges extending from the opposing sides of the backdrop for channeling oil into the open mouth of said upper portion of the splatter guard.
